(19) United States
(12) Patent Application Publication
(10) Pub. No.: US 2020/0240602 A1
(43) Pub. Date: Jul. 30, 2020

(54) SYSTEMS AND METHODS FOR OPTIMIZING SEARCHLIGHT OPERATION PARAMETERS USED TO PERFORM INTELLIGENT SEARCHLIGHT CONTROL

(71) Applicant: HONEYWELL INTERNATIONAL INC., Morris Plain, NJ (US)

(72) Inventor: Jinming Huang, Beijing (CN)

(73) Assignee: HONEYWELL INTERNATIONAL INC., Morris Plains, NJ (US)

(21) Appl. No.: 16/257,948

(22) Filed: Jan. 25, 2019

(51) Int. Cl. F21S 8/00; F21V 21/15; B60Q 1/24; B64D 47/04; G06K 9/00

(52) U.S. Cl. CPC F21S 8/003; F21V 21/15; G06K 9/0063; B64D 47/04; B60Q 1/245

(57) ABSTRACT

A method for controlling a searchlight onboard a vehicle to search for a target using an illuminated area. The method obtains position data (including at least a current azimuth value) and attitude data (including at least a current elevation value) for the searchlight; calculates a point of interest (POI) for the searchlight and a defined search area to search for the target, based on the current azimuth value and the current elevation value, the POI comprising a searchlight center point of impact or a moving target location; optimizes a searchlight coverage area for the defined search area, based on the POI; computes an adjustment to current parameters of the searchlight for generating the optimized searchlight coverage area, wherein the set of adjusted parameters comprises at least one of an adjusted illumination area and an adjusted illumination density value; and initiates operation of the searchlight using the set of adjusted parameters.

### TECHNICAL FIELD

Embodiments of the subject matter described herein relate generally to controlling a searchlight. More particularly, embodiments of the subject matter relate to automatically generating control commands for maximizing searchlight coverage during searchlight operation.

### BACKGROUND

A searchlight is a spotlight apparatus that generally combines a light source with a mirrored parabolic reflector to project a powerful beam of light of approximately parallel rays in a particular direction. Searchlights are usually constructed such that the spotlight can be swiveled to perform various operations requiring focused and intense illumination. Searchlights may be implemented onboard various vehicles, including airborne vehicles, land-based vehicles, and unmanned vehicles. Searchlights generally play a role in different land-based and airborne missions at night, including law enforcement missions, search and rescue missions, coast guard operations, offshore operations, emergency medical services, and the like.

Searchlights are often operated manually, such that a user adjusts searchlight position and orientation parameters based on his own subjective perception of necessary adjustments to achieve a preferred effect. However, manual operation of a searchlight diverts user attention from critical mission tasks, does not provide precise tracking data for a particular object of interest, does not facilitate searches conducted along a specified area or roadmap, and does not provide an automatic response to mission condition changes.

Accordingly, it is desirable to provide intelligent control of a searchlight for particular types of applications or missions. Furthermore, other desirable features and characteristics will become apparent from the subsequent detailed description and the appended claims, taken in conjunction with the accompanying drawings and the foregoing technical field and background.

### BRIEF SUMMARY

Some embodiments of the present disclosure provide a method for performing electromechanical control of a searchlight onboard a vehicle to search for a target using an illuminated area, by a computing device comprising at least one processor and a system memory element. The method obtains position data and attitude data for the searchlight, by the at least one processor, wherein the position data comprises at least a current azimuth value, and wherein the attitude data comprises at least a current elevation value; calculates a point of interest (POI) for the searchlight and a defined search area to search for the target, based on the current azimuth value and the current elevation value for the searchlight onboard the vehicle, by the at least one processor, wherein the POI comprises at least one of a searchlight center point of impact and a moving target location; optimizes a searchlight coverage area for the defined search area, based on the POI, to create an optimized searchlight coverage area, by the at least one processor; computes an adjustment to current parameters of the searchlight for generating the optimized searchlight coverage area, to determine a set of adjusted parameters for the searchlight, by the at least one processor, wherein the set of adjusted parameters comprises at least one of an adjusted illumination area and an adjusted illumination density value; and initiates operation of the searchlight onboard the vehicle using the set of adjusted parameters, by the at least one processor.

Some embodiments of the present disclosure provide a computing device for performing electromechanical control of a searchlight onboard a vehicle to search for a target using an illuminated area. The computing device includes: a system memory element; a communication device configured to exchange data transmissions with the searchlight onboard the vehicle; and at least one processor communicatively coupled to the system memory element and the communication device, the at least one processor configured to: obtain position data and attitude data for the searchlight, wherein the position data comprises at least a current azimuth value, and wherein the attitude data comprises at least a current elevation value; calculate a point of interest (POI) for the searchlight and a defined search area to search for the target, based on the current azimuth value and the current elevation value for the searchlight onboard the vehicle, wherein the POI comprises at least one of a searchlight center point of impact and a moving target location; optimize a searchlight coverage area for the defined search area, based on the POI, to create an optimized searchlight coverage area; compute an adjustment to current parameters of the searchlight for generating the optimized searchlight coverage area, to determine a set of adjusted parameters for the searchlight, wherein the set of adjusted parameters comprises at least one of an adjusted illumination area and an adjusted illumination density value; and initiate operation of the searchlight onboard the vehicle using the set of adjusted parameters, via the communication device.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a system for providing intelligent automated control of search mission equipment including a vehicle-based searchlight system, in accordance with the disclosed embodiments;

FIG. 2 is a functional block diagram of a computing device for use in a system for providing intelligent automated control of search mission equipment including a vehicle-based searchlight system, in accordance with the disclosed embodiments;

FIG. 3 is a diagram of a graphical user interface (GUI) 300 for use in a system for providing intelligent automated control and optimization of search mission equipment, including a vehicle-based searchlight system, in accordance with the disclosed embodiments;

FIG. 4 is a diagram of an optimized searchlight coverage area for a search area defined by a camera operating in conjunction with the searchlight apparatus, in accordance with the disclosed embodiments;

FIG. 5 is a diagram 500 of coordinate systems used to perform computations to optimize searchlight operation parameters used to control the searchlight system, for an aircraft-based searchlight system, in accordance with the disclosed embodiments;

FIG. 6 is a flow chart that illustrates an embodiment of a process for performing electromechanical control of a searchlight onboard a vehicle to search for a target using an illuminated area generated by the searchlight, in accordance with the disclosed embodiments;

FIG. 7 is a flow chart that illustrates an embodiment of a process for calculating a point of interest (POI) for operation of a searchlight, in accordance with the disclosed embodiments;

FIG. 8 is a flow chart that illustrates an embodiment of a process for optimizing a searchlight coverage area to create an optimized searchlight coverage area, in accordance with the disclosed embodiments;

FIG. 9 is a flow chart that illustrates a second embodiment of a process for optimizing a searchlight coverage area to create an optimized searchlight coverage area, in accordance with the disclosed embodiments;

FIG. 10 is a flow chart that illustrates a third embodiment of a process for optimizing a searchlight coverage area to create an optimized searchlight coverage area, in accordance with the disclosed embodiments;

FIG. 11 is a flow chart that illustrates an embodiment of a process for identifying an operating mode for performing the electromechanical control of a searchlight, in accordance with the disclosed embodiments; and

FIG. 12 is a flow chart that illustrates an embodiment of a process for performing coordinated operation of the searchlight with one or more vehicle onboard sensors communicatively coupled to the searchlight, in accordance with the disclosed embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The subject matter presented herein relates to systems and methods for controlling and optimizing operations for a vehicle-mounted searchlight. More specifically, the subject matter relates to optimizing a surface-based illumination area produced by a spotlight beam generated and projected by a searchlight apparatus operating onboard a vehicle. The searchlight coverage area is used to perform searching, tracking, and illuminating operations for a target, based on a defined search area bounded by a vehicle onboard sensor field-of-view. Contemplated herein are techniques for accurately calculating a point of interest (POI) for the searchlight coverage area using vehicle position and attitude values, determining optimization parameters based on vehicle onboard sensor data and searchlight apparatus capabilities, and optimizing the searchlight coverage area by adjusting the illumination region and/or adjusting the illumination density. Using vehicle parameters and searchlight parameters obtained dynamically and in real-time, searchlight operations are automatically initiated and automatically optimized for improved searchlight performance onboard the vehicle.

Certain terminologies are used with regard to the various embodiments of the present disclosure. An optimized searchlight coverage area is a geographic area illuminated by a searchlight that has been enhanced for a particular application, and is used to increase visibility and tracking for a target at a particular point of interest, for a moving target, and/or for a plurality of targets. Searchlight operating modes provide additional functionality for a searchlight system that includes a searchlight apparatus, one or more vehicle onboard sensors, and a searchlight system controller or computing device configured to provide system control. Searchlight operating modes may be user-selected based on user preference, current conditions, and/or a particular situation requiring searchlight use. Generally, a vehicle-based searchlight system includes: (i) the searchlight apparatus that provides illumination according to an orientation and other positioning, (ii) at least one computing device or processor-based control system that operates the searchlight system in accordance with preconfigured instructions, and (iii) the one or more vehicle onboard sensors providing current condition data used by the searchlight apparatus and the processor-based control system to operate the searchlight apparatus. Vehicle onboard sensors used in a searchlight system may include a camera system or other image capture system, a night vision imaging system, an infrared imaging system, an electro-optical imaging system, or the like.

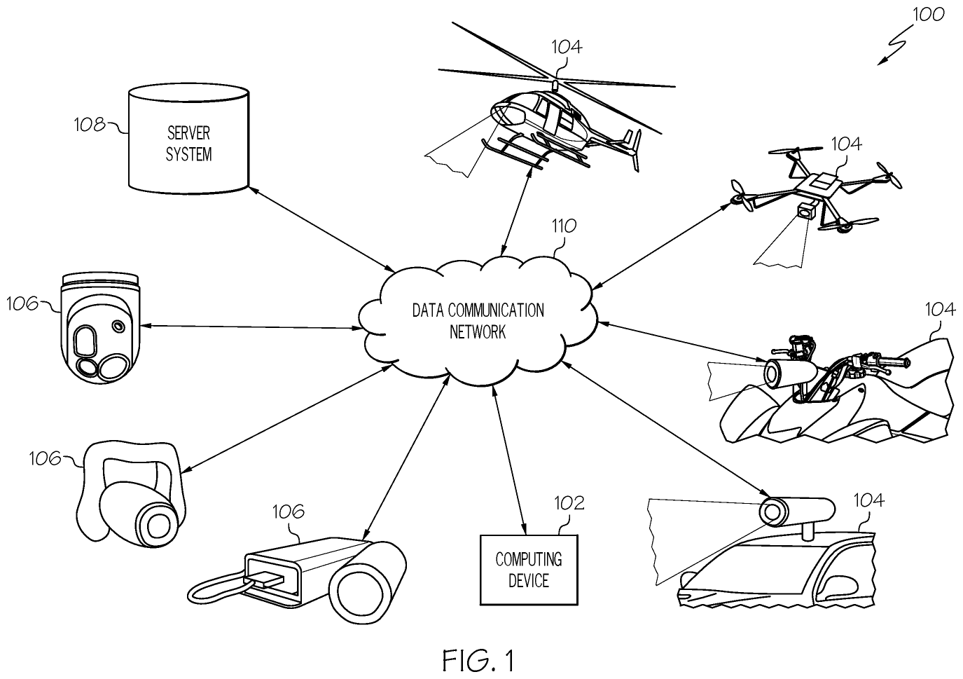

Referring now to the figures, FIG. 1 is a system 100 for providing intelligent automated control of search mission equipment including vehicle-based searchlight system, in accordance with the disclosed embodiments. The system 100 operates to optimize searchlight coverage and to provide efficient and automated control of a searchlight 104 (as part of a searchlight system) for use onboard a vehicle. The system 100 may include, without limitation, a computing device 102 that communicates with a searchlight 104 onboard a vehicle, one or more sensors 106 onboard the vehicle, and at least one server system 108, via a data communication network 110. In practice, certain embodiments of the system 100 may include additional or alternative elements and components, as desired for the particular application.

The computing device 102 may be implemented by any computing device that includes at least one processor, some form of memory hardware, a user interface, and communication hardware. For example, the computing device 102 may be implemented using a personal computing device, such as a tablet computer, a laptop computer, a personal digital assistant (PDA), a smartphone, or the like. In this scenario, the computing device 102 is capable of storing, maintaining, and executing an Electronic Flight Bag (EFB) application configured to optimize searchlight coverage and to provide efficient and automated control of a searchlight 104. In other embodiments, the computing device 102 may be implemented using a computer system onboard the vehicle, wherein the vehicle-based computer system is configured to optimize searchlight coverage and to provide efficient and automated control of a searchlight 104.

The searchlight 104 may be implemented using any type of spotlight mounted or otherwise positioned for use onboard a vehicle. Exemplary embodiments of the searchlight 104 are shown affixed to aircraft (e.g., fixed-wing aircraft, rotary-wing aircraft), unmanned aircraft (e.g., drones), all-terrain vehicles (ATVs), trucks, or the like. The searchlight 104 is an illumination device that includes a luminous source (e.g., a lamp) and a mirrored parabolic reflector to project a powerful beam of light of approximately parallel rays in a particular direction. The searchlight 104 is configured to provide the spotlight beam according to a position and orientation of the searchlight 104, and is usually capable of adjusting orientation of the spotlight beam by swiveling, turning, or pointing the lamp mechanism generating the spotlight beam. The searchlight 104 may be permanently or temporarily affixed to the vehicle, as required for a particular application. The vehicle may be any type of vehicle suitable for use in performing operations requiring a searchlight 104 and capable of searchlight positioning or affixing, including search and rescue operations, law enforcement operations, or the like.

The one or more sensors 106 onboard the vehicle may be implemented as a camera system or other image capture system, a night vision imaging system, an infrared imaging system, an electro-optical imaging system, or the like. The vehicle-based searchlight system 100 may be used to optimize searchlight operations for a static target or a moving target. In embodiments where the optimized searchlight operations are used to illuminate a moving target, the one or more sensors 106 may be used for object tracking. The one or more sensors 106 are coupled to the searchlight 104 based on a mission command request or a mission scene preconfiguration. Additionally, for applications where the vehicle is implemented as an aircraft, the one or more sensors 106 may also include one or more aircraft onboard avionics systems configured to provide aircraft position data, aircraft attitude data, aircraft heading data, and other aircraft parameters applicable to searchlight coverage area optimization computations.

The server system 108 may include any number of application servers, and each server may be implemented using any suitable computer. In some embodiments, the server system 108 includes one or more dedicated computers. In some embodiments, the server system 108 includes one or more computers carrying out other functionality in addition to server operations. The server system 108 may store and provide any type of data used to perform calculations applicable to searchlight coverage area optimization. Such data may include, without limitation: vehicle position data, vehicle elevation data, matrix transformation data, searchlight data, camera/imaging system data, object/target tracking data, and other data compatible with the computing device 102.

The computing device 102 is usually located onboard the vehicle, and the computing device 102 communicates with the searchlight 104 and the one or more sensors 106 via wired and/or wireless communication connection. The computing device 102 and the server system 108 are generally disparately located, and the computing device 102 communicates with the server system 108 via the data communication network 110 and/or via communication mechanisms onboard the vehicle. The data communication network 110 may be any digital or other communications network capable of transmitting messages or data between devices, systems, or components. In certain embodiments, the data communication network 110 includes a packet switched network that facilitates packet-based data communication, addressing, and data routing. The packet switched network could be, for example, a wide area network, the Internet, or the like. In various embodiments, the data communication network 110 includes any number of public or private data connections, links or network connections supporting any number of communications protocols. The data communication network 110 may include the Internet, for example, or any other network based upon TCP/IP or other conventional protocols. In various embodiments, the data communication network 110 could also incorporate a wireless and/or wired telephone network, such as a cellular communications network for communicating with mobile phones, personal digital assistants, and/or the like. The data communication network 110 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

During typical operation, the computing device 102 obtains position data and attitude data associated with the searchlight 104 positioned on the vehicle, from the one or more sensors 106 and/or the remote server system 108. The computing device 102 then uses the position data and the attitude data to calculate a point of interest (POI) of the searchlight coverage area that includes an illuminated region on the ground or other surface (e.g., a body of water). The computing device 102 uses the calculated POI to construct a field of view for the search area, and optimizes the searchlight coverage area by adjusting the illumination area and/or the light density of the output beam produced by the searchlight 104. The computing device 102 is further configured to continuously and dynamically obtain searchlight parameters, during operation of the vehicle and vehicle-based searchlight 104, and to update the optimized searchlight coverage area based on the newly obtained and updated parameters.

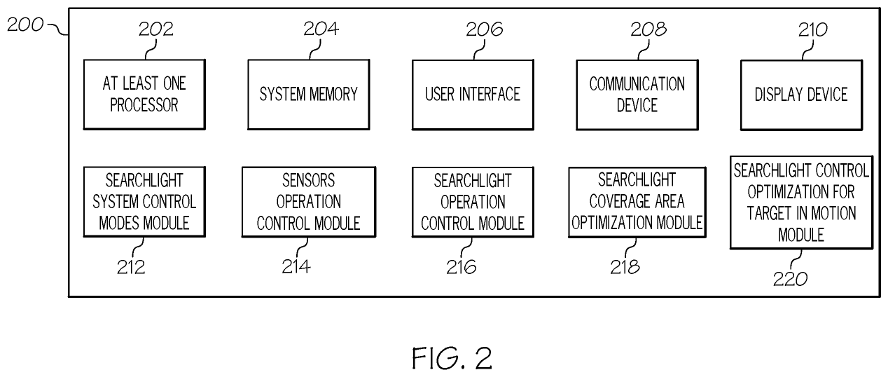

FIG. 2 is a functional block diagram of a computing device 200 for use in a system for providing intelligent automated control of search mission equipment, in accordance with the disclosed embodiments. It should be noted that the computing device 200 can be implemented with the computing device 102 depicted in FIG. 1. In this regard, the computing device 200 shows certain elements and components of the computing device 102 in more detail. The computing device 200 generally includes, without limitation: at least one processor 202; a system memory 204 element; a user interface 206; a communication device 208; a display device 210; a searchlight system control modes module 212; a sensors operation control module 214; a searchlight operation control module 216; a searchlight coverage area optimization module 218; and a searchlight control optimization for target in motion module 220. These elements and features of the computing device 200 may be operatively associated with one another, coupled to one another, or otherwise configured to cooperate with one another as needed to support the desired functionality—in particular, providing real-time optimization of searchlight system operations onboard a vehicle, as described herein. For ease of illustration and clarity, the various physical, electrical, and logical couplings and interconnections for these elements and features are not depicted in FIG. 2. Moreover, it should be appreciated that embodiments of the computing device 200 will include other elements, modules, and features that cooperate to support the desired functionality. For simplicity, FIG. 2 only depicts certain elements that relate to the searchlight system optimization techniques described in more detail below.

The at least one processor 202 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the at least one processor 202 may be realized as one or more microprocessors, controllers, microcontrollers, or state machines. Moreover, the at least one processor 202 may be implemented as a combination of computing devices, e.g., a combination of digital signal processors and microprocessors, a plurality of microprocessors, one or more microprocessors in conjunction with a digital signal processor core, or any other such configuration.

The at least one processor 202 is communicatively coupled to the system memory 204. The system memory 204 is configured to store any obtained or generated data associated with optimizing searchlight system operations, graphical elements associated with optimization of operations performed by the searchlight system, and application data associated with Electronic Flight Bag (EFB) or other types of executable applications (i.e., “apps”) for user interaction with the searchlight system, including optimizing searchlight system operations. The system memory 204 may be realized using any number of devices, components, or modules, as appropriate to the embodiment. Moreover, the computing device 200 could include system memory 204 integrated therein and/or a system memory 204 operatively coupled thereto, as appropriate to the particular embodiment. In practice, the system memory 204 could be realized as RAM memory, flash memory, EPROM memory, EEPROM memory, registers, a hard disk, a removable disk, or any other form of storage medium known in the art. In certain embodiments, the system memory 204 includes a hard disk, which may also be used to support functions of the computing device 200. The system memory 204 can be coupled to the at least one processor 202 such that the at least one processor 202 can read information from, and write information to, the system memory 204. In the alternative, the system memory 204 may be integral to the at least one processor 202. As an example, the at least one processor 202 and the system memory 204 may reside in a suitably designed application-specific integrated circuit (ASIC).

The user interface 206 may include or cooperate with various features to allow a user to interact with the computing device 200. Accordingly, the user interface 206 may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the computing device 200. For example, the user interface 206 could be manipulated by an operator to select an operating mode for and initiate performing operations of the searchlight system using the selected operating mode, to initiate operation of a searchlight system optimization application, or to terminate operations of a searchlight system optimization application, as described herein. In certain embodiments, the user interface 206 may include or cooperate with various features to allow a user to interact with the computing device 200 via graphical elements rendered on a display element (e.g., the display device 210). Accordingly, the user interface 206 may initiate the creation, maintenance, and presentation of a graphical user interface (GUI). In certain embodiments, the display device 210 implements touch-sensitive technology for purposes of interacting with the GUI. Thus, a user can manipulate the GUI by moving a cursor symbol rendered on the display device 210, or by physically interacting with the display device 210 itself for recognition and interpretation, via the user interface 206.

The communication device 208 is suitably configured to communicate data between the computing device 200 and at least: a searchlight apparatus, a searchlight apparatus controller, one or more vehicle onboard sensors operating cooperatively with the searchlight apparatus, and one or more remote servers external to the vehicle. The communication device 208 may transmit and receive communications over a wireless local area network (WLAN), the Internet, a satellite uplink/downlink, a cellular network, a broadband network, a wide area network, or the like. As described in more detail below, data received by the communication device 208 may include, without limitation: vehicle data (e.g., vehicle position data, vehicle attitude data, vehicle heading data); searchlight operation data (e.g., control command data, illumination density capabilities and limits, searchlight coverage area capabilities and limits); searchlight operation mode data; vehicle onboard sensors data; searchlight optimization data for a static target; and searchlight optimization data and tracking data for a moving target, and other data compatible with the computing device 200. Data provided by the communication device 208 may include, without limitation: control commands for a vehicle-based searchlight system, optimized control commands for the vehicle-based searchlight system, activation and termination commands for the vehicle-based searchlight system, and the like.

The display device 210 is configured to display various icons, text, and/or graphical elements associated with optimization of a vehicle-based searchlight system, or the like. In an exemplary embodiment, the display device 210 is communicatively coupled to the user interface 206 and the at least one processor 202. The at least one processor 202, the user interface 206, and the display device 210 are cooperatively configured to display, render, or otherwise convey one or more graphical representations or images associated with optimizing operations of the vehicle-based searchlight system on the display device 210, as described in greater detail below. In an exemplary embodiment, the display device 210 is realized as an electronic display configured to graphically display fuel tankering recommendation data, as described herein. In some embodiments, the computing device 200 is an integrated computer system onboard a vehicle (e.g., an aircraft), the display device 210 is located within the vehicle, and is thus implemented as an integrated vehicle display. In other embodiments, the display device 210 is implemented as a display screen of a standalone, personal computing device (e.g., laptop computer, tablet computer) configured to store, maintain, and execute an Electronic Flight Bag (EFB) application or other application for optimizing operations of the vehicle-based searchlight system. It will be appreciated that although the display device 210 may be implemented using a single display, certain embodiments may use additional displays (i.e., a plurality of displays) to accomplish the functionality of the display device 210 described herein.

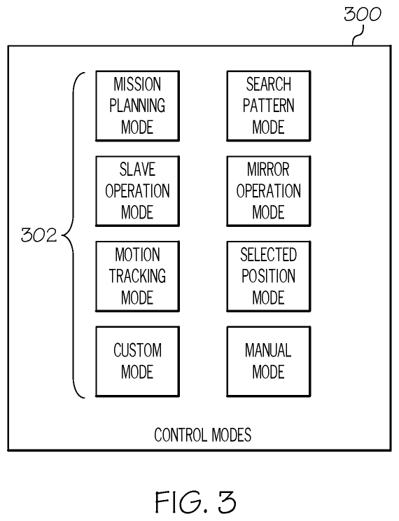

The searchlight system control modes module 212 is configured to determine appropriate control modes for operation of the vehicle-based searchlight system that is communicatively coupled to the computing device 200. To determine one or more appropriate control modes for the searchlight system, the searchlight system control modes module 212 presents graphical elements for user interaction with a searchlight control optimization application, via the user interface 206 and the display device 210. One exemplary embodiment of such user-interactive graphical elements is presented with regard to FIG. 3, including additional detail. In some embodiments, the searchlight system control modes module 212 receives user input selections (via the user interface 206) of one or more user-selected control modes for the searchlight system. Control modes presented for user selection may include, but are not limited to: a mission planning mode, a search pattern mode, a motion tracking mode, a selected position mode, and the like. In some embodiments, the searchlight system control modes module 212 obtains a command for cooperative operation of the searchlight apparatus with one or more vehicle onboard sensors (generally controlled via the sensors operation control module 214). The command or other instructions to initiate and execute cooperative operation of the searchlight and the sensors may be received as user input via the user interface 206 or obtained from a storage location in system memory 204. Cooperative operation may include, but is not limited to, one of the following control modes: a synchronized operating arrangement; a master-slave operating arrangement; a mirror operating arrangement; and the like. It should be appreciated that the searchlight optimization procedure described herein may be generalized to any control mode, such that the searchlight optimization procedure may be used during an activated state of any of the disclosed control modes.

The sensors operation control module 214 is configured to communicate with the one or more vehicle onboard sensors for purposes of control and optimization of operations of the communicatively coupled searchlight apparatus onboard the vehicle. To perform control operations for the vehicle onboard sensors, the sensors operation control module 214 transmits or otherwise provides commands or other types of instructions for operation of the sensors onboard the vehicle, such that each of the one or more vehicle onboard sensors functions to support the optimization of the searchlight operations. The sensors operation control module 214 also initiates sensor operations compatible with selected control modes (via the searchlight system control modes module 212). The one or more vehicle onboard sensors may be implemented as a camera or other image capture device, a night vision imaging system, an infrared imaging or sensor system, an optical imaging or sensor system, or the like. Based on the type of sensor implemented as part of the searchlight system (e.g., the searchlight apparatus, the searchlight controller, the vehicle-onboard sensors), the sensors operation control module 214 generates appropriate command instructions, which may include: turning or otherwise adjusting an orientation of a vehicle onboard sensor to point the sensor toward a particular direction; requesting sensor data associated with field-of-view details for the sensor; terminating operation of one or more of the vehicle onboard sensors, and the like.

The searchlight operation control module 216 is configured to control operation of a searchlight apparatus that is communicatively coupled to the computing device 200 and the one or more vehicle onboard sensors (controlled via the sensors operation control module 214). To control the searchlight apparatus, the searchlight operation control module 216 either (i) directly controls operation of the searchlight by providing control commands directly to the searchlight, wherein the control commands initiate operation of the searchlight; or (ii) transmits control commands that include executable instructions for execution by a searchlight controller, processing board, or other internal computer circuitry or embedded computing hardware that controls the searchlight. The searchlight operation control module 216 is further configured to transmit optimized control commands (generated by the searchlight coverage area optimization module 218) to the searchlight apparatus for optimized control and performance.

The searchlight coverage area optimization module 218 is configured to optimize a searchlight coverage area by enhancing a searchlight coverage area applicable to the searchlight apparatus communicatively coupled to the computing device 200. The searchlight coverage area optimization module 218 is further configured to create optimized control commands that include optimized control parameters (e.g., optimized illumination area values, optimized illumination density values), and to provide the optimized control commands to the searchlight operation control module 216 for use in controlling the searchlight apparatus.

A searchlight coverage area is a geographic area illuminated by a searchlight, or in other words, a searchlight illumination area where the “coverage” indicates a region that is “covered” by the illumination from a beam of light produced by the searchlight apparatus. An optimized searchlight coverage area is a searchlight illumination area that has been enhanced for a particular application, and that is used to increase the visibility of, and improve the tracking of, a target at a particular point of interest, a moving target, and/or a plurality of targets. The searchlight coverage area optimization module 218 generally optimizes an illumination area produced by the searchlight and an illumination density used by the searchlight by increasing these parameters. For example, the searchlight coverage area optimization module 218 increases the illumination area by expanding or enlarging the region of spotlight coverage, and increases the illumination density by increasing brightness of the spotlight beam generated by the searchlight. Typically, the searchlight coverage area optimization module 218 increases parameters for optimization. However, it should be appreciated that the searchlight coverage area optimization module 218 may increase or decrease applicable parameters, as required for the particular application. For example, the illumination area may be decreased to optimize the searchlight coverage area in scenarios where a target location (e.g., a point of interest) has been accurately calculated and the entirety of a size of the current searchlight coverage area is not required for accurate illumination or tracking of the target. In this example, the searchlight coverage area optimization module 218 may permit the current illumination density to remain at the same current value or to decrease slightly, while maintaining current visibility conditions for the target location.

The searchlight control optimization for target in motion module 220 is configured to optimize motion tracking capabilities for the searchlight system (e.g., the searchlight apparatus, the searchlight controller, the vehicle onboard sensors) when using the searchlight to search for, track, and illuminate a target that is in motion. The searchlight control optimization for target in motion module 220 optimizes motion tracking capabilities for the searchlight system by performing automatic POI tracking, or in other words, by performing moving target tracking. The POI is treated as a center point of interest for the ellipse-shaped searchlight illumination area, and when the POI target moves, the center of the mission area changes in a corresponding way. The projection of the searchlight onto the POI target is ellipse-shaped, and in order to maximize illuminance coverage based on the POI target trajectory, the searchlight control optimization for target in motion module 220 adjusts the spotlight illumination area centering on the POI target with the best-fit illumination of the specified coverage area (e.g., a camera coverage area, a vehicle-based sensor coverage area). The searchlight control optimization for target in motion module 220 is further configured to provide appropriate optimized control commands to the sensors operation control module 214 and/or the searchlight operation control module 216, such that the vehicle onboard sensors and the searchlight apparatus are controlled according to optimized searchlight procedures and parameters associated with motion tracking and rapid searchlight coverage area changes, as described herein.

In practice, the searchlight system control modes module 212, the sensors operation control module 214, the searchlight operation control module 216, the searchlight coverage area optimization module 218, and/or the searchlight control optimization for target in motion module 220 may be implemented with (or cooperate with) the at least one processor 202 to perform at least some of the functions and operations described in more detail herein. In this regard, the searchlight system control modes module 212, the sensors operation control module 214, the searchlight operation control module 216, the searchlight coverage area optimization module 218, and/or the searchlight control optimization for target in motion module 220 may be realized as suitably written processing logic, application program code, or the like.

FIG. 3 is a diagram of a graphical user interface (GUI) 300 for use in a system for providing intelligent automated control and optimization of search mission equipment, including a searchlight system. It should be noted that the GUI 300 described herein with regard to FIG. 3 is one exemplary embodiment of the functionality described previously with regard to FIG. 2 (e.g., the searchlight system control modes module 212). As shown, the GUI 300 presents user-selectable graphical elements 302 representing control modes for the vehicle-based searchlight system described previously with regard to FIG. 1. The GUI 300 is generally presented by a computing device (see reference 102, FIG. 1; reference 200, FIG. 2) for user interaction with the searchlight system, including initiation or termination of an application for optimizing searchlight operations, wherein the application may be implemented as an Electronic Flight Bag (EFB) or other type of user-interactive application provided onboard the vehicle. In this exemplary embodiment, the GUI 300 presents the user-selectable graphical elements 302 representing control modes, including: a mission planning mode, a slave operation mode, a motion tracking mode, a user-configurable custom mode, a search pattern mode, a mirror operation mode, a selected position mode, and a manual mode. In the embodiment shown, a user touchscreen selection of one of the user-selectable graphical elements activates the mode associated with the selected one of the user-selectable graphical elements, for the searchlight apparatus.

The mission planning mode may be selected by a user to initiate operations associated with flight planning, including mission planning for a planned search area or a roadmap for use during searchlight use. Using the mission planning mode, the searchlight system is configured to control the searchlight to perform searchlight functions (e.g., typical searchlight operations, optimization of searchlight operations as described herein) while traveling using a specific trajectory according to the recognized roadmap or projected mission planning data. The search pattern mode may be selected by a user to initiate operations associated with various search patterns (e.g., an S-pattern trajectory, a parallel pattern trajectory) configured for use with the searchlight. User-selection of the search pattern mode graphical element activates the search pattern mode for a particular search pattern, and initiates use and control of the searchlight apparatus according to the selected, particular search pattern. The slave operation mode may be selected by a user to initiate operations of the searchlight using a master-slave arrangement, wherein the searchlight is configured to operate as the slave to one of the vehicle onboard sensors that is operating as the master. As described herein, one or more of the vehicle onboard sensors may be implemented as an image capture device or sensor (e.g., a camera, an infrared sensor, an optical sensor, a night vision imaging system), and the searchlight apparatus (e.g., the slave) may operate according to instructions received from the image capture device or sensor (e.g., the master). The mirror operation mode may be selected by a user to initiate operations of the searchlight using a “mirror” operating arrangement, wherein the searchlight apparatus and the vehicle sensors are configured to operate while turned toward opposite directions.

The motion tracking mode may be selected by a user to initiate operations of the vehicle onboard sensors to perform object detection operations, to adjust a direction of data collection based on a detected object, and to initiate searchlight operations (including optimization of searchlight operations) to track a moving target based on the new, adjusted direction of the detected object.

The selected position mode may be selected by a user to initiate operations of the searchlight using a particular identified location (e.g., a point of interest) on the ground or surface of water, wherein the searchlight apparatus is configured to swivel an orientation of the searchlight toward the selected position and to lock onto the selected position for stable and consistent use of the searchlight apparatus until the selected position is changed by the user or until the selected control mode is changed by the user. The custom operation mode may be selected by a user to initiate operations of the searchlight according to a user-configurable definition of a specific searchlight function. The manual mode may be selected by a use to permit manual user control over searchlight operations. Additional control modes (not shown) may be presented by the computing device (see reference 200, FIG. 2) via the GUI 300, including a searchlight synchronization mode for searchlight apparatus control and coordinated operation with other vehicle onboard sensors. Each of the above-described intelligent control modes for automated and intelligent performance of searchlight operations is user-accessible, on-demand, via touchscreen user interface (see reference 206, FIG. 2) and for control of the searchlight apparatus based on the mission objective.

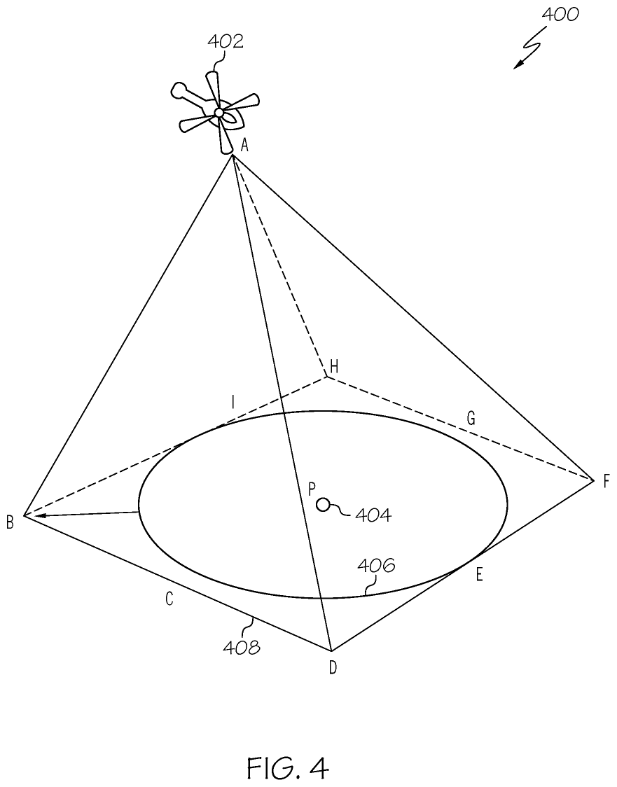

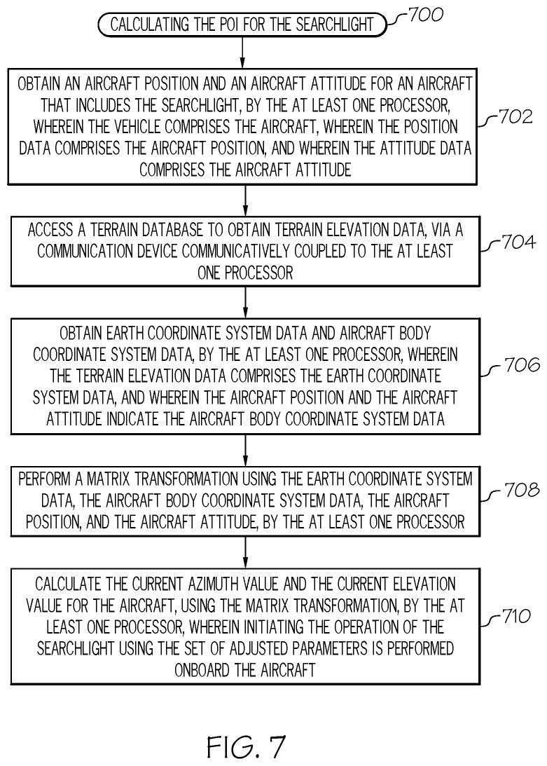

FIG. 4 is a diagram 400 of a best-fit illumination searchlight area for an image capture device, in accordance with the disclosed embodiments. It should be appreciated that the diagram 400 illustrated by FIG. 4 is one exemplary embodiment of an aircraft-based system for implementing process 700, as described in FIG. 7. FIG. 4 illustrates an optimized illumination area (i.e., an enhanced, adjusted, or otherwise optimized searchlight coverage area 406) that has been enlarged to “best-fit” a camera coverage area 408, such that the searchlight apparatus enables efficient target searching, target tracking, and target illumination via the enlarged illumination area (i.e., enlarged searchlight coverage area 406). Here, a vehicle-based searchlight system includes the searchlight apparatus, a camera or other vehicle onboard sensor, and a searchlight controller or other computing hardware configured to control functionality of the searchlight apparatus onboard the aircraft 402. During use, the searchlight apparatus generates a spotlight beam that produces a searchlight coverage area 406 on the ground surface, water surface, or other surface applicable to searchlight operations.

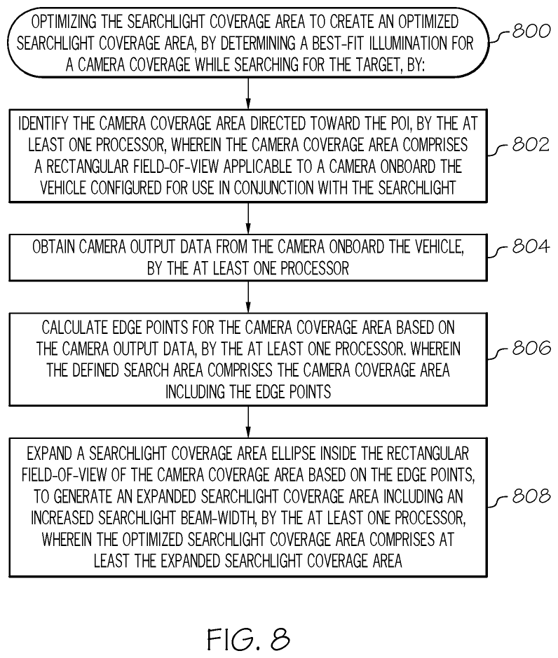

The searchlight apparatus is generally directed or pointed toward the same direction used by the camera. Thus, the searchlight coverage area 406 is generally projected onto a surface in the same geographic region as a defined search area visible to the camera. The defined search area may also be referred to as a camera coverage area 408 that includes a rectangular field-of-view for the camera operating in conjunction with the searchlight apparatus onboard the aircraft 402. Edge points BDFH of the camera coverage area 408 represent the boundary lines of a camera vision area (i.e., the field-of-view for the camera). Edges ICEG are applicable to an ellipse-shape representing the illumination area (i.e., searchlight coverage area 406) produced by the searchlight apparatus. The point of interest (POI) 404 is also represented by P and is the center of point of impact on the ground surface for the searchlight apparatus. As shown, the searchlight coverage area 406 is optimized by a computing device (see reference 102, FIG. 1; reference 200, FIG. 2) communicatively coupled to the searchlight apparatus, to maximize the illuminated region of the surface based on the camera coverage area 408, as described with regard to process 800 of FIG. 8. The computing device calculates a location of a point of interest (POI) 404 using an azimuth value and an elevation for the searchlight apparatus. In this particular example, since the searchlight apparatus is positioned onboard the aircraft 402, the azimuth value is an aircraft azimuth value, and the elevation value is an aircraft altitude value. Thus, the aircraft azimuth value and the aircraft altitude value are obtained via a communication connection to one or more avionics devices onboard the aircraft 402. After calculating the location of the point of interest, the computing device obtains camera data and computes edge points for the camera coverage area 408, which are then used to compute expanded or enlarged ellipse edge parameters such that the ellipse representing the searchlight coverage area 406 is maximized to encompass a largest potential geographic area bounded by the polygon representing of the camera coverage area 408.

As shown, the POI 404 may be calculated for a static target or a moving target. The intelligent searchlight is intended for automatic POI tracking, or in other words, moving target tracking. When the POI target moves, the center of the mission area (e.g., POI 404) changes correspondingly. The projection of the searchlight onto the POI target (e.g., the searchlight coverage area 406) is ellipse-shaped. In order to maximize an area of illuminance coverage based on the moving POI target trajectory, the system adjusts the spotlight on the target with the best-fit illumination of the specified coverage area (e.g., the camera coverage area 408).

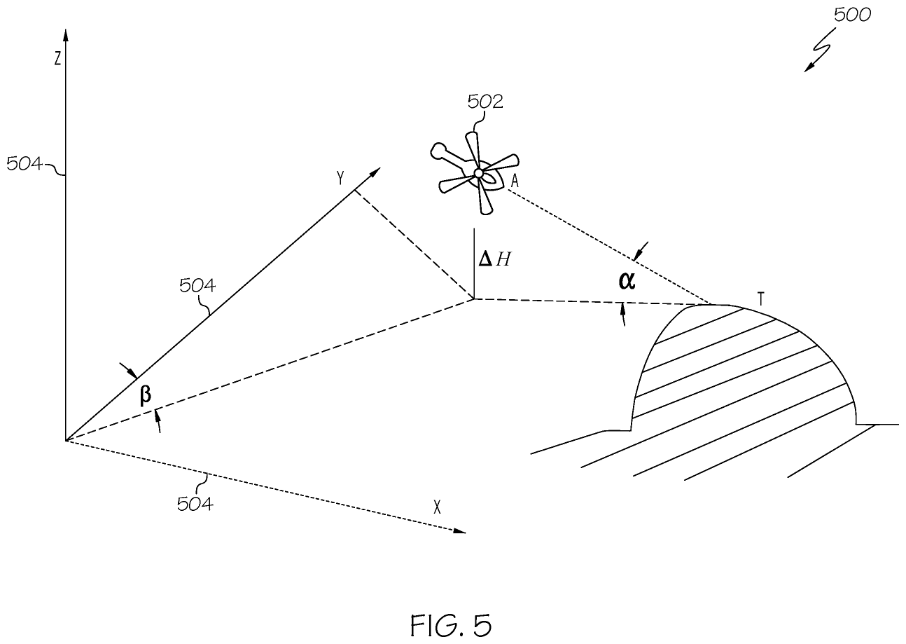

FIG. 5 is a diagram 500 of coordinate systems used to perform computations for providing intelligent automated control of search mission equipment, for an aircraft-based searchlight system, in accordance with the disclosed embodiments. It should be appreciated that the diagram 500 illustrated by FIG. 5 is one exemplary embodiment of an aircraft-based system for implementing process 700, as described in FIG. 7, and the diagram 500 includes additional description for the system described previously with regard to FIG. 4. Similar to diagram 400 of FIG. 4, the diagram 500 also optimizes an illumination area (i.e., searchlight coverage area 406) to “best-fit” a camera coverage area, such that the searchlight apparatus enables efficient target searching, target tracking, and target illumination via the enlarged illumination area. During use, the searchlight apparatus generates a spotlight beam that produces a searchlight coverage area on the ground surface, water surface, or other surface applicable to searchlight operations. The diagram 500 illustrates an aircraft 502 that includes the vehicle-based searchlight system that includes: (i) the searchlight apparatus that provides illumination according to an orientation and other positioning, (ii) at least one computing device or processor-based control system that operates the searchlight system in accordance with preconfigured instructions, and (iii) the one or more vehicle onboard sensors providing current condition data used by the searchlight apparatus and the processor-based control system to operate the searchlight apparatus. Vehicle onboard sensors used in a searchlight system may include a camera system or other image capture system, a night vision imaging system, an infrared imaging system, an electro-optical imaging system, or the like.

As shown, diagram 500 provides the coordinate system data used by a computing device (see reference 102, FIG. 1; reference 200, FIG. 2) to determine the equivalent azimuth and elevation angles for the searchlight apparatus relative to the frame of the aircraft 502, using a matrix transformation between an earth coordinate system 504 and an aircraft body coordinate system. Because the aircraft position, aircraft altitude, and terrain elevation data are obtained and therefore known, the azimuth and elevation of the aircraft (based on the earth coordinate system 504) are used to calculate the point of interest (POI) on the surface of the Earth. A resultant azimuth angle and a resultant elevation angle are calculated using the true azimuth angle and the true elevation angle for the onboard searchlight apparatus based on the aircraft attitude (e.g., pitch, roll, yaw), heading, magnetic variation, relative azimuth, and relative elevation. Using the resultant azimuth angle, the resultant elevation angle, and the aircraft position, the point of interest (POI) on the ground surface is calculated. The searchlight apparatus is then adjusted by optimized control commands generated by the computing device, in order to increase visibility and focus for the target to be searched, tracked, and/or illuminated.

By matrix transformation from the body frame of the aircraft 502 to the earth coordinate system 504, a resultant unit vector is calculated, using equation (1), as shown:

x″=f₁(a, e, r, p, h); y″=f₂(a, e, r, p, h); and z″=f₃(a, e, r, p); (1):

where a is the angle of the azimuth, e is the angle of elevation, r is the angle of roll, p is the angle of pitch, and h is the angle of the heading of the helicopter. Using equation (1), current aircraft position data, an onboard searchlight azimuth angle, and an onboard searchlight elevation angle, the POI on the ground surface for the searchlight coverage area is determined. As shown, β is not the elevation angle used for the computation above but is the resultant elevation angle, which can be determined by the equivalent azimuth and elevation angles of searchlight after taking into account the pitch, roll and heading of the aircraft. Also as shown, T indicates the searchlight coverage area.

As shown in FIGS. 4 and 5, camera coverage area edge points (BDFH) defining boundaries for the camera field-of-view are calculated using the available camera output data, and the size of the ellipse representing the searchlight coverage area is determined based the search area defined by the camera coverage area. For continuous operation of the searchlight apparatus during flight of the aircraft 502, and to maximize efficient searchlight coverage on-demand, the ellipse parameters are dynamically calculated, in real-time, based on the defined corners or edge points for the camera field-of-view. The computing device adjusts the searchlight working parameters according to a control procedure. Using the control procedure, the computing device: (i) selects an applicable control mode (see reference 300, 302 of FIG. 3) based on a user-entered selection or an identified operational scenario; (ii) calculates the center of point of interest (POI) of the searchlight coverage area or the movement of a target POI; and (iii) determines boundaries of a search area (i.e., the camera coverage area) for conducting the search, based on the searchlight elevation value, the searchlight azimuth value, and additional vehicle onboard sensor data (e.g., the camera data). Once the boundaries of the search area are determined, the computing device: (iv) calculates corresponding ellipse parameters for the searchlight coverage area; and (v) to optimize the searchlight coverage area by maximizing the search area size, the computing device calculates the parameters of the ellipse representing the searchlight coverage area with the best-fit beam-width. Then the computing device: (vi) efficiently adjusts an illumination density based on user preferences and/or power constraints for the searchlight apparatus. The computing device: (vii) converts a searchlight control command to include the calculated brightness and beam-width parameters, thereby optimizing power consumption and light usage to meet mission requirements.

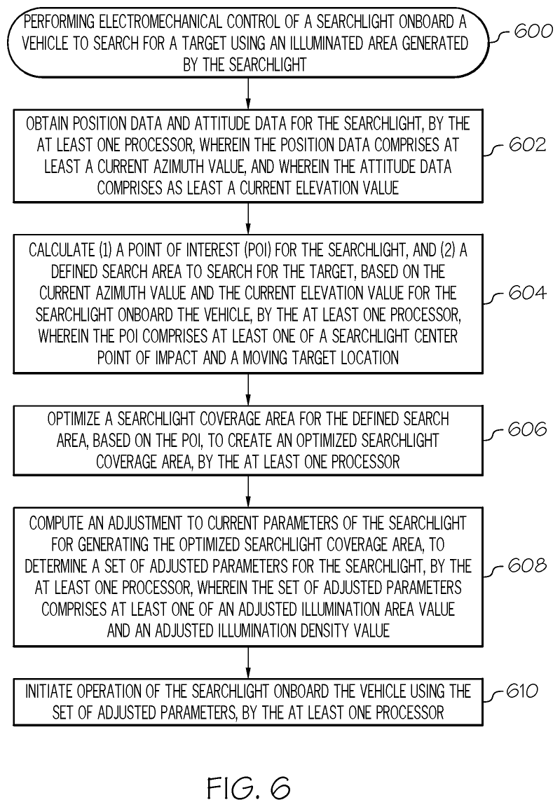

FIG. 6 is a flow chart that illustrates an embodiment of a process 600 for performing electromechanical control of a searchlight onboard a vehicle to search for a target using an illuminated area generated by the searchlight, in accordance with the disclosed embodiments. The process 600 is generally implemented by a computing device or other type of searchlight system controller, for automatic control of a searchlight apparatus using an optimized searchlight coverage area. First, the process 600 obtains position data and attitude data for the searchlight, by the at least one processor (step 602). The position data includes at least a current azimuth value for the searchlight, and the attitude data includes at least a current elevation value for the searchlight. As described herein, the searchlight is generally implemented onboard a vehicle, and the current azimuth value and the current elevation value are defined relative to the position of the searchlight located onboard the vehicle. Azimuth and elevation are the coordinates that define a position of a searchlight used as part of a vehicle onboard searchlight system. The azimuth is an angular measurement in a spherical coordinate system, which is usually measured in degrees. The vector from an origin (e.g., an observer) to a position of the searchlight is projected perpendicularly onto a reference plane, and the azimuth is the angle between the projected vector and a reference vector on the reference plane. The elevation is the vertical angular distance between the searchlight onboard the vehicle and the local plane (e.g., the ground level, the sea level). Here, the process 600 obtains the position data and the elevation data from one or more position sensors onboard the vehicle. For a ground vehicle, the process 600 may obtain the position data from a vehicle onboard Global Positioning System (GPS) or other vehicle onboard position device. Also for a ground vehicle, the elevation value can be calculated based on the offset of the vehicle and searchlight position.

Next, the process 600 calculates a point of interest (POI) for the searchlight and a defined search area to search for the target, based on the current azimuth value and the current elevation value for the searchlight onboard the vehicle, by the at least one processor (step 604). One suitable methodology for calculating the POI for the searchlight and the defined search area is described below with reference to FIG. 7. The POI is implemented as a searchlight center point of impact for searching for and illuminating a static target, or a location for performing object tracking to search for, track, and illuminate a moving target. For aircraft applications and ground vehicle applications, the process 600 calculates the POI in a similar manner One key difference between aircraft POI calculations and ground vehicle POI calculations lies in a change in the height (i.e., elevation) value. For an aircraft, the process 600 can obtain the change in height (ΔH) from the radio altimeter onboard the aircraft. For a ground vehicle, the process 600 can obtain the change in height (ΔH) based on the installation offset for the searchlight above the ground.

The process 600 then optimizes a searchlight coverage area for the defined search area, based on the POI, to create an optimized searchlight coverage area, by the at least one processor (step 606). Suitable methodologies for optimizing a searchlight coverage area for the defined search area are described below with reference to FIGS. 8, 9, and 10. It should be noted that each of the embodiments described in FIGS. 8, 9, and 10 may be implemented as a standalone optimization procedure, or as a combination of one or more of the processes, without departing from the scope of the present disclosure. The process 600 may perform searchlight coverage area optimization by adjusting the size and/or brightness of the illumination for the searchlight coverage area. For example, the searchlight coverage area may be enlarged, when appropriate, by increasing a beam-width of the searchlight apparatus. Thus, the searchlight coverage area may provide a larger illuminated geographic area to conduct a search for a target, to perform searchlight system operations, including: tracking of a moving target, or to spotlight a target at a known location for a period of time (such as may be required during a rescue operation). As another example, a searchlight coverage area may be illuminated to a greater degree, by increasing an illumination density, to increase visibility within the searchlight coverage area for conducting the previously-described searchlight system operations.

Next, the process 600 computes an adjustment to current parameters of the searchlight for generating the optimized searchlight coverage area, to determine a set of adjusted parameters for the searchlight, by the at least one processor (step 608). The set of adjusted parameters comprises at least one of an adjusted illumination area value and an adjusted illumination density value. Here, the process 600 determines whether changes to a size or brightness level of the searchlight coverage area are required to optimize the searchlight coverage area.

The process 600 then initiates operation of the searchlight onboard the vehicle using the set of adjusted parameters, by the at least one processor (step 610). To initiate operation of the searchlight using the set of adjusted parameters, the process 600 may execute instructions to perform searchlight control directly, or transmit instructions to a control system for the searchlight to trigger operation of the searchlight according to the adjusted orientation.

FIG. 7 is a flow chart that illustrates an embodiment of a process 700 for calculating a point of interest (POI) for operation of a searchlight onboard an aircraft, in accordance with the disclosed embodiments. It should be appreciated that the process 700 described in FIG. 7 represents one embodiment of step 604 described above in the discussion of FIG. 6, including additional detail. Further, although the embodiment described below with regard to process 700 is applicable to one specific type of vehicle (e.g., an aircraft), it should be appreciated that any vehicle may be applicable to the searchlight system operations described herein. The POI generally refers to a location for a searchlight center point of impact for the searchlight coverage area that is applicable to a static target location, or to a location applicable to a moving target.

The motion tracking indicates pointing or directing the searchlight coverage area toward the POI target along its movement in real-time. The process 700 can extract a relative position of the moving target in the pixel domain, and extract the moving target trajectory based on the relative positioning and ownship position. The calculation of POI position is not necessary for a static location, and could be extended to moving target scenarios as well, since the position of the moving target may not be known in advance.

First, the process 700 obtains an aircraft position and an aircraft attitude for an aircraft that includes the searchlight, by the at least one processor (step 702). The process 700 is one particular implementation of step 604 of FIG. 6 that is applicable to an aircraft, and in the embodiment described by process 700, the vehicle comprises the aircraft, wherein the position data comprises the aircraft position, and wherein the attitude data comprises the aircraft attitude. Here, the process 700 obtains current aircraft position data and current aircraft attitude data from one or more aircraft onboard avionics systems. The aircraft position data includes aircraft altitude data, aircraft heading data, magnetic variation data, and azimuth data. The aircraft attitude data includes at least pitch data, roll data, and yaw data. The process 700 also accesses a terrain database to obtain terrain elevation data, via a communication device communicatively coupled to the at least one processor (step 704). The terrain database may be stored locally onboard the aircraft, or may be accessed from a storage location external to the aircraft (e.g., a remote server or other data storage location).

The process 700 obtains earth coordinate system data (see reference 504, FIG. 5) and aircraft body coordinate system data, by the at least one processor (step 706). For purposes of the process 700, the terrain elevation data includes the earth coordinate system data, and a combination of the aircraft position data and the aircraft attitude data indicates the aircraft body coordinate system data. The earth coordinate system used herein may also be referred to as a geographic coordinate system, and is a three-dimensional (3D) reference system for location points on the surface of Earth. Generally, the applicable unit of measure for the geographic coordinate system is decimal degrees, and a location point is referenced using latitude and longitude coordinate values for angle measurements. The aircraft body coordinate system is an aircraft-specific coordinate system that is relative to the frame of the aircraft.

The process 700 performs a matrix transformation using the earth coordinate system data, the aircraft body coordinate system data, the terrain elevation data, the aircraft position, and the aircraft attitude, by the at least one processor (step 708). The process 700 uses techniques that are well-known and commonly used in the art for performing the matrix transformation between the earth coordinate system and the aircraft body coordinate system. Typical techniques may include mapping coordinates of an inertial frame to a fixed frame, using translation and rotation to perform a coordinate system transformation between a global coordinate system and a local coordinate system, using Euler angles to represent aircraft body orientation (e.g., pitch, roll, yaw), and the like.

The process 700 calculates the current azimuth value and the current elevation value for the aircraft, using the matrix transformation, by the at least one processor (step 710). The process 700 provides the current azimuth value and the current elevation value that are used to optimize a searchlight coverage area, and compute an adjustment to current parameters of the searchlight to optimize the coverage area (see FIG. 6). As described with regard to reference 610 of FIG. 6, the step of initiating the operation of the searchlight using the set of adjusted parameters, is performed onboard the aircraft.

FIG. 8 is a flow chart that illustrates an embodiment of a process 800 for optimizing a searchlight coverage area to create an optimized searchlight coverage area, in accordance with the disclosed embodiments. It should be appreciated that the process 800 described in FIG. 8 represents one embodiment of step 606 described above in the discussion of FIG. 6, including additional detail. The process 800 optimizes the searchlight coverage area by determining a best-fit illumination for a camera-coverage area while searching for the target. The best-fit illumination is a largest potential coverage area for the beam of light produced by the searchlight, wherein the largest potential coverage area is constrained by a defined search area including field-of-view for a camera that operates cooperatively with the searchlight apparatus. The best-fit illumination is an optimized searchlight coverage area described previously with regard to FIGS. 4-5. Generally, a vehicle-based searchlight system includes: (i) the searchlight apparatus that provides illumination according to an orientation and other positioning, (ii) at least one computing device or processor-based control system that operates the searchlight system in accordance with preconfigured instructions, and (iii) one or more vehicle onboard sensors providing current condition data used by the searchlight apparatus and the processor-based control system to operate the searchlight apparatus. Vehicle onboard sensors used in a searchlight system may include a camera system or other image capture system, a night vision imaging system, an infrared imaging system, an electro-optical imaging system, or the like. For simplicity in describing the process 800, the term “camera” is used in place of one or more vehicle onboard sensors. However, it should be appreciated that any of the vehicle onboard sensors described herein may be implemented and used during execution of the process 800.

First, the process 800 identifies the camera coverage area directed toward the point of interest (POI), by the at least one processor (step 802). The camera coverage area is a rectangular field-of-view applicable to the camera that is onboard the vehicle and configured for use in conjunction with the searchlight. The camera coverage area is defined by the size of the field-of-view for the camera, and images captured by the camera are bounded by the field-of-view. Onboard the vehicle, the camera is pointed toward a particular direction, and thus is configured to capture image data in the particular direction, based on the camera position and/or orientation, and the field-of-view limits for the particular camera. The POI is described previously with regard to FIGS. 2 and 4-5, and refers to a static or moving position of a target for spotting and/or tracking using the searchlight system. The direction of the camera, applicable to the camera coverage area, is pointed toward the POI for searchlight use. Here, the process 800 identifies the camera coverage area directed toward the POI.

The process 800 obtains camera output data from the camera onboard the vehicle, by the at least one processor (step 804), and the process 800 then calculates edge points for the camera coverage area based on the camera output data, by the at least one processor (step 806). The defined search area comprises the camera coverage area including the edge points. The edge points may be calculated for the camera coverage area based on camera output data for a particular camera using well-known and commonly used techniques in the art. The projection of the camera onto the ground is rectangular in shape, and thus the process 800 is required to calculate the four corners of the projection. Here, the process 800 calculates the approximate camera field of view based on intrinsic parameters and a camera azimuth, a camera elevation angle, a current position of the camera, and a relative altitude above the ground for the camera.

The process 800 expands a searchlight coverage area ellipse inside the rectangular field-of-view of the camera coverage area based on the edge points, to generate an expanded searchlight coverage area including an increased searchlight beam-width, by the at least one processor (step 808). Here, the process 800 optimizes the searchlight coverage area by enlarging the searchlight coverage area to fill the rectangular camera coverage area. Generally, the rectangular camera coverage area is a largest potential defined search area, and the searchlight coverage area may be optimized to illuminate the largest potential defined search area. To accomplish this, the process 800 computes edges of the ellipse-shaped searchlight coverage area to meet the edges of the rectangular camera coverage area. The optimized searchlight coverage area comprises at least the expanded searchlight coverage area.

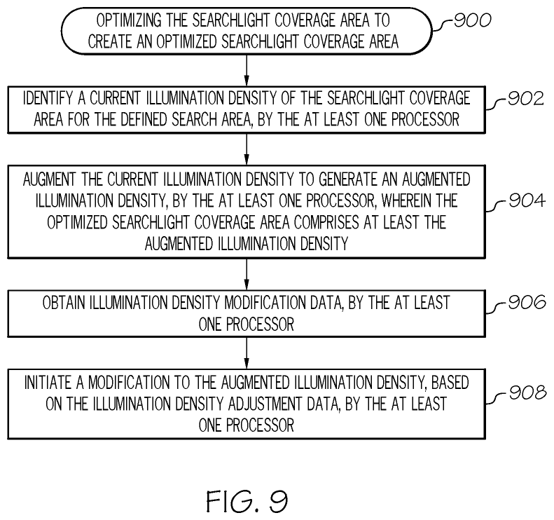

FIG. 9 is a flow chart that illustrates a second embodiment of a process 900 for optimizing a searchlight coverage area to create an optimized searchlight coverage area, in accordance with the disclosed embodiments. It should be appreciated that the process 900 described in FIG. 9 represents one embodiment of step 606 described above in the discussion of FIG. 6, including additional detail. First, the process 900 identifies a current illumination density of the searchlight coverage area for the defined search area, by the at least one processor (step 902). The illumination density is a type of Lighting Power Density (LPD), and may be measured by watts of lighting per square meter (watts/m²). Here, the process 900 identifies the illumination density using the known impacted area requiring illumination. The illumination density is maintained to a particular level. A maximum value of the power is known as well, and the illumination area may be adjusted based on the impacted area size.

The process 900 then augments the current illumination density to generate an augmented illumination density, by the at least one processor (step 904). An optimized searchlight coverage area is a searchlight coverage area that has been enhanced, improved, or otherwise augmented based on an identified point of interest, a current searchlight azimuth, and a current searchlight elevation. Here, the optimized searchlight coverage area is configured to be “brighter” or in other words, more brightly illuminated, than the original searchlight coverage area by augmenting the illumination density produced by the searchlight apparatus, thus increasing the current searchlight illumination density to produce an optimized illumination density. Here, the optimized searchlight coverage area includes at least the augmented illumination density.

In certain embodiments, the process 900 performs additional adjustments to the illumination density generated by the searchlight apparatus, based on additional conditions or restrictions associated with current operation of the searchlight. For example, in some embodiments the process 900 obtains power constraint data for the searchlight, and initiates a modification to the augmented illumination density based on the power constraint data. In this scenario, the process 900 ensures that power constraints for a particular model of searchlight apparatus are not exceeded during operation of the searchlight apparatus. As another example, in some embodiments the process 900 receives user input preferences associated with searchlight illumination density preferences, via a user interface communicatively coupled to the at least one processor, and initiates a modification to the augmented illumination density based on the user input preferences. In this scenario, the process 900 ensures that user preferences regarding brightness (i.e., illumination density) and/or power usage for the searchlight apparatus are not exceeded during operation of the searchlight apparatus.

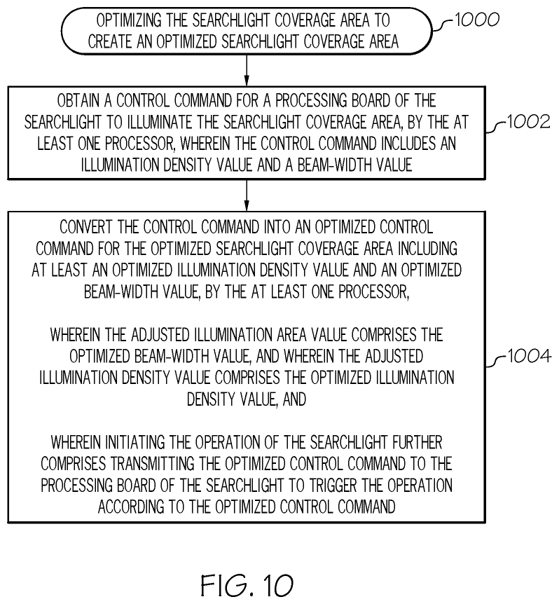

FIG. 10 is a flow chart that illustrates a third embodiment of a process 1000 for optimizing a searchlight coverage area to create an optimized searchlight coverage area, in accordance with the disclosed embodiments. It should be appreciated that the process 1000 described in FIG. 10 represents one embodiment of step 606 described above in the discussion of FIG. 6, including additional detail. An optimized searchlight coverage area is a geographic area illuminated by a searchlight that has been enhanced for a particular application, and is used to increase visibility and tracking for a target at a particular point of interest, for a moving target, and/or for a plurality of targets.

The process 1000 obtains a control command for a processing board of the searchlight to illuminate the searchlight coverage area, by the at least one processor (step 1002). The control command includes at least an illumination density value and a beam-width value. The illumination density is described previously with regard to FIG. 9. A beam-width for a searchlight is a size of the beam of light produced by the searchlight, which is generally variable according to the hardware capabilities a particular searchlight. A searchlight beam-width may be user-configurable or automatically configurable by a searchlight system controller or communicatively coupled computing device, based on user preferences, the particular application, current conditions, and/or current circumstances.

Here, the process 1000 obtains the control command that provides parameters for the intensity and the size of the light provided by the searchlight apparatus, which is used to control the searchlight apparatus according to a previously stored configuration or a user-selected configuration. In some embodiments, the control command may also include an instruction to re-position, adjust, or maintain an orientation of the searchlight apparatus. In this scenario, the searchlight system is configured to operate using the illumination density, the beam-width value, and the searchlight orientation.

The process 1000 then converts the control command into an optimized control command for the optimized searchlight coverage area to include an optimized illumination density value and an optimized beam-width value (step 1004). As described herein, an optimized searchlight coverage area is a searchlight coverage area that has been enhanced based on an identified point of interest, a current searchlight azimuth, and a current searchlight elevation. The optimized searchlight coverage area is generally larger and/or brighter than the original searchlight coverage area, and thus increases a current searchlight illumination density to produce an optimized illumination density, and increases a current searchlight beam-width to produce an optimized beam-width value. The adjusted illumination area value comprises the optimized beam-width value, and the adjusted illumination density value comprises the optimized illumination density value. Further, in the embodiment described by process 1000, initiating the operation of the searchlight onboard the vehicle using the set of adjusted parameters (see reference 610 of FIG. 6) is accomplished by transmitting the optimized control command to the processing board of the searchlight to trigger the operation according to the optimized control command, via a communication device communicatively coupled to the at least one processor.

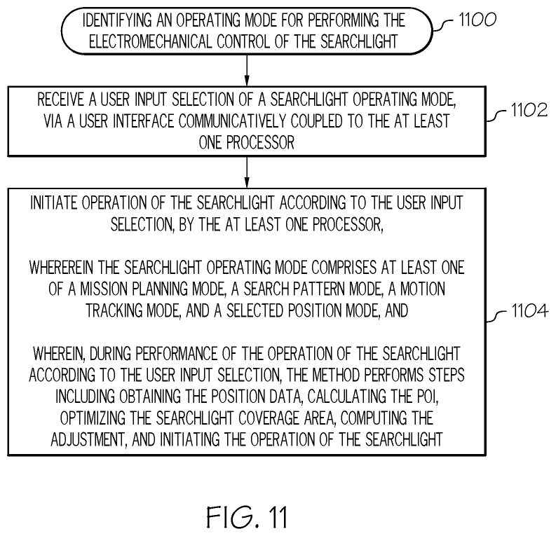

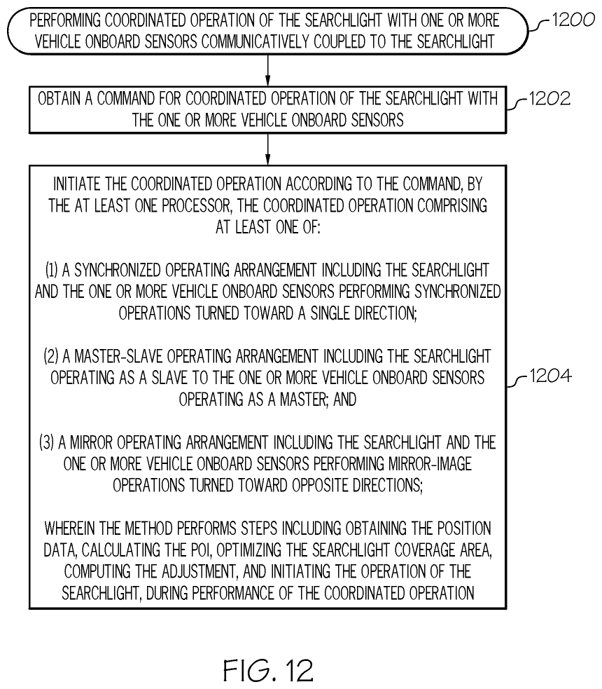

FIG. 11 is a flow chart that illustrates an embodiment of a process 1100 for identifying an operating mode for performing the electromechanical control of a searchlight, in accordance with the disclosed embodiments. It should be appreciated that the process 1100 described in FIG. 11 may be executed prior to performance of process 600 of FIG. 6, resulting in initiation of an operating mode under which the searchlight system operates to perform process 600. Thus, the process 600 performs steps including obtaining the position data, calculating the POI, optimizing the searchlight coverage area, computing the adjustment, and initiating the operation of the searchlight, during performance of the operation of the searchlight according to the user input selection. It should be appreciated that the searchlight system operating modes may include a coordinated operation of the searchlight apparatus and one or more vehicle onboard sensors, as described herein with regard to FIGS. 3 and 12, and that one or more operating modes may be selected and used, depending on a particular application.

First, the process 1100 receives a user input selection of a searchlight operating mode, via a user interface communicatively coupled to the at least one processor (step 1102). Searchlight operating modes provide additional functionality for a searchlight system that includes a searchlight apparatus, one or more vehicle onboard sensors, and a searchlight system controller or computing device configured to provide system control. Searchlight operating modes may be user-selected based on user preference, current conditions, and/or a particular situation requiring searchlight use. Searchlight operating modes are described previously with regard to FIG. 3, and may include one or more of the following, without limitation: a mission planning mode, a search pattern mode, a motion tracking mode, and a selected position mode, and other operating modes, as described herein.

After receiving the user input selection of an operating mode (step 1102), the process 1100 then initiates the operation of the searchlight according to the user input selection, by the at least one processor (step 1104). Here, the process 1100 transmits instructions to the searchlight apparatus and to the one or more vehicle onboard sensors to trigger execution of the searchlight system operating mode, as required by the user input selection.

FIG. 12 is a flow chart that illustrates an embodiment of a process 1200 for performing coordinated operation of the searchlight with one or more vehicle onboard sensors communicatively coupled to the searchlight, in accordance with the disclosed embodiments. As described herein, the process 1200 described in FIG. 12 may be executed prior to performance of process 600 of FIG. 6, resulting in initiation of the coordinated operation of the searchlight and sensors, under which the searchlight system operates to perform process 600. Thus, the process 600 performs steps including obtaining the position data, calculating the POI, optimizing the searchlight coverage area, computing the adjustment, and initiating the operation of the searchlight, during performance of the coordinated operation. It should be appreciated that the coordinated operation may be implemented as a searchlight system operating mode, as described previously with regard to FIGS. 3 and 11, and that one or more operating modes may be selected and used, depending on a particular application.

First, the process 1200 obtains a command for coordinated operation of the searchlight with one or more vehicle onboard sensors communicatively coupled to the searchlight (step 1202). Here, the process 1200 obtains a command or other type of instruction for operating the searchlight apparatus and one or more sensors cooperatively, in order to obtain meaningful sensor data while illuminating a particular location with the searchlight. In some embodiments, the process 1200 obtains a user-entered command for cooperative operation via a user interface of the computing device (see reference 102, FIG. 1; reference 206, FIG. 2). In other embodiments, however, the process 1200 obtains a pre-configured and stored command for cooperative operation of the vehicle onboard sensor and the searchlight. The process 1200 then initiates the coordinated operation according to the command, by the at least one processor, in response to obtaining the command (step 1204). Here, the process 1200 transmits instructions to the searchlight apparatus and to the one or more vehicle onboard sensors to trigger execution of the coordinated operation, as required by the command

Generally, a vehicle-based searchlight system includes: (i) the searchlight apparatus that provides illumination according to an orientation and other positioning, (ii) at least one computing device or processor-based control system that operates the searchlight system in accordance with preconfigured instructions, and (iii) the one or more vehicle onboard sensors providing current condition data used by the searchlight apparatus and the processor-based control system to operate the searchlight apparatus. Vehicle onboard sensors used in a searchlight system may include a camera system or other image capture system, a night vision imaging system, an infrared imaging system, an electro-optical imaging system, or the like.

A coordinated operation of the searchlight with the vehicle onboard sensors typically establishes a relationship between a direction from which image capture is performed by the one or more sensors, and a direction for the searchlight to illuminate a search area. The direction for the searchlight is based on a searchlight orientation that includes an azimuth value and an elevation value for the searchlight apparatus. The coordinated operation may include one of the following: (1) a synchronized operating arrangement including the searchlight and the one or more vehicle onboard sensors performing synchronized operations turned toward a single direction; (2) a master-slave operating arrangement including the searchlight operating as a slave to the one or more vehicle onboard sensors operating as a master; and (3) a mirror operating arrangement including the searchlight and the one or more vehicle onboard sensors performing mirror-image operations turned toward opposite directions.

When using the synchronized operating arrangement, the vehicle onboard sensor and the searchlight apparatus automatically cooperatively function to turn toward the same direction to illuminate and view (i.e., obtain imaging data for) the same search area. Thus, when a vehicle onboard sensor is turned toward a first direction, the searchlight apparatus may be configured to automatically turn toward the same direction, for operation of the searchlight apparatus. In this scenario, the vehicle onboard sensor obtains sensor data from the first direction, while the searchlight apparatus simultaneously illuminates the first direction. When using the master-slave operating arrangement, the vehicle onboard sensor and the searchlight apparatus automatically cooperatively function, such that the searchlight apparatus operates as a slave to the vehicle onboard sensor that operates as a master. Thus, the vehicle onboard sensor directs operation of both of the searchlight apparatus and the vehicle onboard sensor itself. In this scenario, the vehicle onboard sensor is configured to provide instructions to the searchlight apparatus, and the searchlight apparatus operates according to the vehicle onboard sensor-supplied instructions. When using the mirror operating arrangement, the vehicle onboard sensor and the searchlight apparatus automatically cooperatively function to turn toward opposite directions to illuminate and view (i.e., obtain imaging data for) a first search area in a first direction and a second search area in a second direction, wherein the first direction and the second direction are opposite directions. Thus, when a vehicle onboard sensor is turned toward a first direction, the searchlight apparatus may be configured to automatically turn toward the opposite direction, for operation of the searchlight apparatus. In this scenario, the vehicle onboard sensor obtains sensor data from the first direction, while the searchlight apparatus simultaneously illuminates the opposite direction.

The various tasks performed in connection with processes 600-1200 may be performed by software, hardware, firmware, or any combination thereof. For illustrative purposes, the preceding description of processes 600-1200 may refer to elements mentioned above in connection with FIGS. 1-5. In practice, portions of processes 600-1200 may be performed by different elements of the described system. It should be appreciated that processes 600-1200 may include any number of additional or alternative tasks, the tasks shown in FIGS. 6-12 need not be performed in the illustrated order, and processes 600-1200 may be incorporated into a more comprehensive procedure or process having additional functionality not described in detail herein. Moreover, one or more of the tasks shown in FIGS. 6-12 could be omitted from embodiments of processes 600-1200 as long as the intended overall functionality remains intact.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIG. 2 depicts one exemplary arrangement of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for performing electromechanical control of a searchlight onboard a vehicle to search for a target using an illuminated area, by a computing device comprising at least one processor and a system memory element, the method comprising:
obtaining position data and attitude data for the searchlight, by the at least one processor, wherein the position data comprises at least a current azimuth value, and wherein the attitude data comprises at least a current elevation value;
calculating a point of interest (POI) for the searchlight and a defined search area to search for the target, based on the current azimuth value and the current elevation value for the searchlight onboard the vehicle, by the at least one processor, wherein the POI comprises at least one of a searchlight center point of impact and a moving target location;
optimizing a searchlight coverage area for the defined search area, based on the POI, to create an optimized searchlight coverage area, by the at least one processor;
computing an adjustment to current parameters of the searchlight for generating the optimized searchlight coverage area, to determine a set of adjusted parameters for the searchlight, by the at least one processor, wherein the set of adjusted parameters comprises at least one of an adjusted illumination area and an adjusted illumination density value; and
initiating operation of the searchlight onboard the vehicle using the set of adjusted parameters, by the at least one processor.

2. The method of claim 1, wherein calculating the POI for the searchlight further comprises:
obtaining an aircraft position and an aircraft attitude for an aircraft that includes the searchlight, by the at least one processor, wherein the vehicle comprises the aircraft, wherein the position data comprises the aircraft position, and wherein the attitude data comprises the aircraft attitude;
accessing a terrain database to obtain terrain elevation data, via a communication device communicatively coupled to the at least one processor; and
calculating the current azimuth value and the current elevation value for the aircraft, based on the aircraft position, the aircraft attitude, and the terrain elevation data, by the at least one processor, wherein initiating the operation of the searchlight using the set of adjusted parameters is performed onboard the aircraft.

3. The method of claim 2, further comprising:
obtaining earth coordinate system data and aircraft body coordinate system data, by the at least one processor, wherein the terrain elevation data indicates the earth coordinate system data, and wherein the aircraft position and the aircraft attitude indicate the aircraft body coordinate system data;
performing a matrix transformation using the earth coordinate system data, the aircraft body coordinate system data, the aircraft position, and the aircraft attitude, by the at least one processor; and
calculating the current azimuth value and the current elevation value for the aircraft, using the matrix transformation, by the at least one processor.

4. The method of claim 1, wherein optimizing the searchlight coverage area further comprises:
determining a best-fit illumination for a camera-coverage area while searching for the target, by:
identifying the camera coverage area directed toward the POI, by the at least one processor, wherein the camera coverage area comprises a rectangular field-of-view applicable to a camera onboard the vehicle configured for use in conjunction with the searchlight;
obtaining camera output data from the camera onboard the vehicle, by the at least one processor;
calculating edge points for the camera coverage area based on the camera output data, by the at least one processor, wherein the defined search area comprises the camera coverage area including the edge points; and
expanding a searchlight coverage area ellipse inside the rectangular field-of-view of the camera coverage area based on the edge points, to generate an expanded searchlight coverage area including an increased searchlight beam-width, by the at least one processor, wherein the optimized searchlight coverage area comprises at least the expanded searchlight coverage area.

5. The method of claim 1, wherein optimizing the searchlight coverage area further comprises:
identifying a current illumination density of the searchlight coverage area for the defined search area, by the at least one processor; and
augmenting the current illumination density to generate an augmented illumination density, by the at least one processor, wherein the optimized searchlight coverage area comprises at least the augmented illumination density.

6. The method of claim 5, further comprising:
obtaining power constraint data for the searchlight, by the at least one processor; and
initiating a modification to the augmented illumination density based on the power constraint data, by the at least one processor.

7. The method of claim 5, further comprising:
receiving user input preferences associated with searchlight illumination density preferences, via a user interface communicatively coupled to the at least one processor; and
initiating a modification to the augmented illumination density based on the user input preferences, by the at least one processor.

8. The method of claim 1, wherein optimizing the searchlight coverage area further comprises:
obtaining a control command for a processing board of the searchlight to illuminate the searchlight coverage area, by the at least one processor, wherein the control command includes an illumination density value and a beam-width value; and
converting the control command into an optimized control command for the optimized searchlight coverage area to include an optimized beam-width value and an optimized illumination density value, wherein the adjusted illumination area comprises the optimized beam-width value, and wherein the adjusted illumination density value comprises the optimized illumination density value; and
wherein initiating the operation of the searchlight onboard the vehicle further comprises:
transmitting the optimized control command to the processing board of the searchlight to trigger the operation according to the optimized control command, via a communication device communicatively coupled to the at least one processor.

9. The method of claim 1, further comprising:
receiving a user input selection of a searchlight operating mode, via a user interface communicatively coupled to the at least one processor; and
initiating the operation of the searchlight according to the user input selection, by the at least one processor;
wherein the searchlight operating mode comprises at least one of a mission planning mode, a search pattern mode, a motion tracking mode, and a selected position mode; and
wherein, during performance of the operation of the searchlight according to the user input selection, the method performs steps including obtaining the position data, calculating the POI, optimizing the searchlight coverage area, computing the adjustment, and initiating the operation of the searchlight.

10. The method of claim 1, further comprising:
obtaining a command for coordinated operation of the searchlight with one or more vehicle onboard sensors communicatively coupled to the searchlight; and
initiating the coordinated operation according to the command, by the at least one processor, the coordinated operation comprising at least one of:
a synchronized operating arrangement including the searchlight and the one or more vehicle onboard sensors performing synchronized operations turned toward a single direction;
a master-slave operating arrangement including the searchlight operating as a slave to the one or more vehicle onboard sensors operating as a master; and
a mirror operating arrangement including the searchlight and the one or more vehicle onboard sensors performing mirror-image operations turned toward opposite directions;
wherein the method performs steps including obtaining the position data, calculating the POI, optimizing the searchlight coverage area, computing the adjustment, and initiating the operation of the searchlight, during performance of the coordinated operation.

11. A computing device for performing electromechanical control of a searchlight onboard a vehicle to search for a target using an illuminated area, the computing device comprising:
a system memory element;
a communication device configured to exchange data transmissions with the searchlight onboard the vehicle; and
at least one processor communicatively coupled to the system memory element and the communication device, the at least one processor configured to:
obtain position data and attitude data for the searchlight, wherein the position data comprises at least a current azimuth value, and wherein the attitude data comprises at least a current elevation value;
calculate a point of interest (POI) for the searchlight and a defined search area to search for the target, based on the current azimuth value and the current elevation value for the searchlight onboard the vehicle, wherein the POI comprises at least one of a searchlight center point of impact and a moving target location;
optimize a searchlight coverage area for the defined search area, based on the POI, to create an optimized searchlight coverage area;
compute an adjustment to current parameters of the searchlight for generating the optimized searchlight coverage area, to determine a set of adjusted parameters for the searchlight, wherein the set of adjusted parameters comprises at least one of an adjusted illumination area and an adjusted illumination density value; and
initiate operation of the searchlight onboard the vehicle using the set of adjusted parameters, via the communication device.

12. The computing device of claim 11, wherein the at least one processor is further configured to calculate the POI for the searchlight by:
obtaining an aircraft position and an aircraft attitude for an aircraft that includes the searchlight, wherein the vehicle comprises the aircraft, wherein the position data comprises the aircraft position, and wherein the attitude data comprises the aircraft attitude;
accessing a terrain database stored by the system memory element, to obtain terrain elevation data; and
calculating the current azimuth value and the current elevation value for the aircraft, based on the aircraft position, the aircraft attitude, and the terrain elevation data, wherein initiating the operation of the searchlight using the set of adjusted parameters is performed onboard the aircraft.

13. The computing device of claim 12, wherein the at least one processor is further configured to:
obtain earth coordinate system data and aircraft body coordinate system data, wherein the terrain elevation data indicates the earth coordinate system data, and wherein the aircraft position and the aircraft attitude indicate the aircraft body coordinate system data;
perform a matrix transformation using the earth coordinate system data, the aircraft body coordinate system data, the aircraft position, and the aircraft attitude; and
calculate the current azimuth value and the current elevation value for the aircraft, using the matrix transformation.

14. The computing device of claim 11, wherein the at least one processor is further configured to optimize the searchlight coverage area by:
determining a best-fit illumination for a camera coverage area while searching for the target, by:
identifying the camera coverage area directed toward the POI, wherein the camera coverage area comprises a rectangular field-of-view applicable to a camera onboard the vehicle configured for use in conjunction with the searchlight;
obtaining camera output data from the camera onboard the vehicle;
calculating edge points for the camera coverage area based on the camera output data, wherein the defined search area comprises the camera coverage area including the edge points; and
expanding a searchlight coverage area ellipse inside the rectangular field-of-view of the camera coverage area based on the edge points, to generate an expanded searchlight coverage area including an increased searchlight beam-width, wherein the optimized searchlight coverage area comprises at least the expanded searchlight coverage area.

15. The computing device of claim 11, wherein the at least one processor is further configured to optimize the searchlight coverage area by:
identifying a current illumination density of the searchlight coverage area for the defined search area; and
augmenting the current illumination density to generate an augmented illumination density, wherein the optimized searchlight coverage area comprises at least the augmented illumination density.

16. The computing device of claim 15, wherein the at least one processor is further configured to:
obtain power constraint data for the searchlight; and
initiate a modification to the augmented illumination density based on the power constraint data.

17. The computing device of claim 15, wherein the at least one processor is further configured to:
receive user input preferences associated with searchlight illumination density preferences, via a user interface communicatively coupled to the at least one processor; and
initiate a modification to the augmented illumination density based on the user input preferences.

18. The computing device of claim 11, wherein the at least one processor is further configured to optimize the searchlight coverage area, by:
obtaining a control command for a processing board of the searchlight to illuminate the searchlight coverage area, wherein the control command includes a beam-width value and an illumination density value; and
converting the control command into an optimized control command for the optimized searchlight coverage area to include an optimized beam-width value and an optimized illumination density value, wherein the adjusted illumination area comprises the optimized beam-width value, and wherein the adjusted illumination density value comprises the optimized illumination density value; and
wherein the at least one processor is further configured to initiate the operation of the searchlight onboard the vehicle, by:
transmitting the optimized control command to the processing board of the searchlight to trigger the operation according to the optimized control command, via the communication device.

19. The computing device of claim 11, wherein the computing device further comprises a user interface communicatively coupled to the at least one processor; and
wherein the at least one processor is further configured to:
receive a user input selection of a searchlight operating mode, via the user interface; and
initiate the operation of the searchlight according to the user input selection, wherein the searchlight operating mode comprises at least one of a mission planning mode, a search pattern mode, a motion tracking mode, and a selected position mode.

20. The computing device of claim 11, wherein the at least one processor is further configured to:
obtain a command for coordinated operation of the searchlight with one or more vehicle onboard sensors communicatively coupled to the searchlight, via the communication device;
initiate the coordinated operation according to the command, the coordinated operation comprising at least one of:
a synchronized operating arrangement including the searchlight and the one or more vehicle onboard sensors performing synchronized operations turned toward a single direction;
a master-slave operating arrangement including the searchlight operating as a slave to the one or more vehicle onboard sensors operating as a master; and
a mirror operating arrangement including the searchlight and the one or more vehicle onboard sensors performing mirror-image operations turned toward opposite directions.
